(19) United States
(12) Patent Application Publication
(10) Pub. No.: US 2011/0060464 A1
(43) Pub. Date: Mar. 10, 2011

(54) Adiabatic control method for isothermal characteristics of reaction vessels

(75) Inventor: Li Young, Bridgewater, NJ (US)

(73) Assignee: Akribio Corp.

(21) Appl. No.: 12/584,565

(22) Filed: Sep. 9, 2009

(51) Int. Cl. G05B 21/00

(52) U.S. Cl. 700/268

(57) ABSTRACT

An adiabatic control method for isothermal reaction vessels for exothermic reactions, includes with a first reaction vessel and a second non-reaction vessel, each having cooling control and adjustment mechanisms. Chemical reactants are added to the first vessel for an isothermal exothermic reaction to create reaction product(s), and appropriate cooling is provided to regulate the rate of reaction. A second vessel non-reactant control material for adiabatic measurements has similar heat capacity and mass to chemical reactants of the first vessel. The second vessel is identically cooled as the first vessel. A pseudo heat of reaction is calculated for the second vessel material utilizing the heat change rate, the control material heat capacity and mass, and it is assumed to be the heat of reaction of the first vessel to identify optimal reaction parameters. The method involves heating, instead of cooling, for endothermic isothermal reactions.

### BACKGROUND OF INVENTION

a. Field of Invention

The present invention relates generally to creating reliable isothermal reaction characteristics and identifying optimal reaction parameters for desired reaction heat profiles over time. This enables users to optimize isothermal reactions. The method involves performing isothermal reactions in a first vessel or reactor, paralleling the isothermal temperature controls (adding or removing heat) to a second (non-reaction) vessel or reactor with at least one non-reacting control material, calculating a pseudo heat of reaction for the adiabatic (pseudo) second vessel or rector, utilizing the heat change over time, the at least one control material heat capacity and mass, and assuming the resulting pseudo heat of reaction of the second vessel is equal to the heat of reaction of the first vessel.

b. Description of Related Art

The following patents are representative of the field pertaining to the present invention:

U.S. Pat. No. 6,852,896 B2 to John E. Stauffer describes an integrated process of preparing a C₂₋₅ alkenyl-substituted aromatic compound using a C₆₋₁₂ aromatic compound and a C₂₋₅ alkane raw materials. The process involves two reaction steps operating in tandem, the first reaction step reacts the C₆₋₁₂ aromatic compound with hydrogen chloride and molecular oxygen in the presence of a catalyst to yield water and mono-, di-, tri-, and higher chlorinated aromatic adducts. The chlorinated compounds from the first reaction step to produce alkane-substituted aromatic compounds which spontaneously dehydrogenate to an alkenyl-substituted aromatic compound and hydrogen chloride. After separating the alkenyl-substituted aromatic product from the hydrogen chloride, the hydrogen chloride is recycled to the first reaction step so that there is no net production or consumption of hydrogen chloride.

U.S. Pat. No. 6,615,914 B1 to Li Young, the inventor herein, describes a reaction vessel system that includes a reaction vessel; a cooling unit functionally connected to the vessel to impart controlled cooling thereto; a heating unit functionally connected to the vessel to impart controlled heating thereto; and control means connected to the cooling unit and the heating unit for programmable automatic control of the cooling unit to control at least one of on/off flow and rate of flow, and to control at least one of on/off heating and rate of heating, including a programmable device. The cooling unit includes a cooling element in proximity to the vessel with at least one inlet port for injection of a phase change coolant, a heat absorbent area and at least one outlet port for removal of the phase change coolant. This is an injector for injecting the coolant in liquid form via the inlet port to the cooling element. In preferred embodiments, the control means includes software, and the system includes and injection physical control device, for cyclical on/off control thereof to establish a predetermined temperature sequence involving a plurality of diverse, programmable temperature levels. The phase change coolant used in the present invention is an environmentally inert material which absorbs heat upon vaporization and has boiling point below room temperature at atmospheric pressure, and may be selected from the group consisting of inert gases, carbon dioxide and nitrogen.

U.S. Pat. No. 6,470,679 B1 to Thomas Ertle describes regenerative working and thermal processes, the drive energy of which is supplied by external combustion of the fuel. The heat supply for this, almost always assumed to be isothermic, is achieved only in exceptional cases, since the flue gases usually have a low specific thermal capacity. The invention explains new types of processes in order to obtain the optimum thermodynamic efficiency heat exchangers and thermal regenerators used in regenerative processes are replaced by regenerative heat exchangers, which comprise a plurality of short regenerators, which are connected by tubular heart exchangers for the heating medium. It is thereby possible to supply the heat to the process not at a fixed but at a sliding temperature. In the same way, regenerative coolers are used for the dissipation of heat from Stirling engines and regenerative heart pumps or refrigeration machines, if, for example, only air is available as heat transfer medium.

U.S. Pat. No. 6,242,657 B1 to Bernd-Michael König et al. describes the reaction of aromatic compounds with nitrating acids comprising HNO₃ and, if appropriate, H₂SO₄ and/or H₂O and/or H₃PO₄ to form aromatic nitro compounds, according to the invention an amount of from 0.5 to 20,000 ppm of one or more surface-active substances from the group of the anionic, cationic, zwitterionic or nonionic surface-active substances is added to the reaction mixture.

U.S. Pat. No. 6,299,852 B1 to Mats Nyström et al. describes a process of continuously producing hydrogen peroxide by direct reaction between hydrogen and oxygen in a gaseous reaction mixture in contact with a catalyst maintained in a reactor, wherein a gaseous reaction mixture containing hydrogen and oxygen is supplied to the reactor through an inlet and hydrogen peroxide enriched gas is withdrawn from the reactor through an outlet. According to the invention the temperature difference in the gaseous reaction mixture in contact with the catalyst between a position just after the inlet to the reactor and a position at the outlet of the reactor is maintained below about 40° C.

U.S. Pat. No. 4,986,076 to Kenneth Kirk et al. describes a method for cooling and maintaining an object at a substantially constant temperature. The method includes adding a salt that dissolves endothermically in water to a mixture containing at least water, a surfactant and an emulsified thermal buffer. The “salt:water:thermal buffer” ratio is such that the reaction provides sufficient endotherm to cool the system to the freezing point of the thermal buffer and effect at least a partial phase change of the thermal buffer. Another version of the invention provides a device for effecting the method. The device has a reaction compartment consisting of two portions separated by a frangible barrier, one portion containing the emulsified thermal buffer in water and the other portion the salt that dissolves endothermically into solution. One specific version of the device is a container for transporting an amputated extremity such as a severed finger to another location for replantation.

U.S. Pat. No. 4,154,099 to Gilbert Blu et al. describes a method of measuring the ratio _{Y} of the specific heats of a fluid at a given constant pressure Cₚ and a constant volume Cᵥ corresponding to a given temperature Tₒ and a given pressure Pₒ. This method comprises the steps of adiabatically compressing a predetermined mass of the fluid to be examined, detecting the maximum pressure value P_{S}, measuring the stabilization pressure P_{T} and computing the specific heat ratio according to the equation: _{Y}=(P_{S}−Pₒ)/(P_{T}−Pₒ).

Notwithstanding the prior art, the present invention is neither taught nor rendered obvious thereby.

### SUMMARY OF INVENTION

The present invention is an adiabatic control method for isothermal characteristics of reaction vessels for both isothermal exothermic and isothermal endothermic reactions. In the case of isothermal exothermic reactions, the present invention includes: a) providing at least one first vessel, being at least one reaction vessel, the at least one first vessel having cooling means; b) providing at least one second vessel, being at least one non-reaction control vessel, the at least one second vessel having cooling means; c) providing control and adjustment means for the first vessel cooling means and for the second vessel cooling means; d) providing chemical reactants to the first vessel for an isothermal exothermic reaction to create at least one reaction product; e) initiating a reaction in the first vessel with the chemical reactants and providing appropriate cooling as necessary to maintain a desired temperature to regulate the rate of reaction; f) providing at least one control material that is non-reactant, to the second vessel for adiabatic measurements wherein the at least one control material has a similar heat capacity to chemical reactants of the first vessel; g) cooling the second vessel in the same manner and rate of heat removal as the first vessel so as to effect temperature reduction over time, and measuring and storing the temperature reduction over time to determine heat change over time for the second vessel; and, h) calculating a pseudo heat of reaction of said at least one material of the second vessel utilizing the heat change over time, the at least one control material heat capacity and mass, and assuming the resulting pseudo heat of reaction of the second vessel is equal to the heat of reaction of the first vessel to create reliable isothermal reaction characteristics and identify optimal reaction parameters for the desired reaction heat profile over time.

In some embodiments of the present invention adiabatic control method for isothermal characteristics of reaction vessels for exothermic reactions, the control and adjustment means includes at least one programmable computer.

In some embodiments of the present invention adiabatic control method for isothermal characteristics of reaction vessels for exothermic reactions, the first vessel and the second vessel are of identical configuration and capacity.

In some embodiments of the present invention adiabatic control method for isothermal characteristics of reaction vessels for exothermic reactions, the initial volumetric amount of chemical reactants of the first vessel is equal to the initial volumetric amount of the at least one control material of the second vessel.

In some embodiments of the present invention adiabatic control method for isothermal characteristics of reaction vessels for exothermic reactions, the cooling means for the first vessel is identical to the cooling means for the second vessel.

In some embodiments of the present invention adiabatic control method for isothermal characteristics of reaction vessels for exothermic reactions, the cooling means is a phase change cooling means.

In some embodiments of the present invention adiabatic control method for isothermal characteristics of reaction vessels for exothermic reactions, the first vessel and the second vessel include temperature sensors connected to a computer, wherein the computer records and stores temperature readings at preprogrammed times for both the first vessel and the second vessel.

In some embodiments of the present invention adiabatic control method for isothermal characteristics of reaction vessels for exothermic reactions, the reaction in the first vessel is performed in a liquid medium and the at least one control material in the second vessel includes a liquid.

In some embodiments of the present invention adiabatic control method for isothermal characteristics of reaction vessels for exothermic reactions, the method steps a) through h) are repeated for a plurality of different stoichiometries of the chemical reactants of the first vessel.

In other embodiments of the present invention adiabatic control method for isothermal characteristics of reaction vessels, the reactions are endothermic reactions, and the method includes: a) providing at least one first vessel, being at least one reaction vessel, the at least one first vessel having a heating means; b) providing at least one second vessel, being at least one non-reaction control vessel, the at least one second vessel having heating means; c) providing control and adjustment means for the first vessel heating means, the second vessel heating means; d) providing chemical reactants to the first vessel for an isothermal endothermic reaction to create at least one reaction product; e) initiating a reaction in the first vessel with the chemical reactants and providing appropriate heating as necessary to maintain a desired temperature to regulate the rate of reaction; f) providing at least one control material that is non-reactant, to the second vessel for adiabatic measurements wherein the at least one control material has a similar heat capacity to chemical reactants of the first vessel; g) heating the second vessel in the same manner and rate of heat input as the first vessel so as to effect temperature increase over time, and measuring and storing the temperature increase over time to determine heat change over time; and, h) calculating a pseudo heat of reaction for the at least one control material of the second vessel utilizing the heat change over time, the at least one control material heat capacity and mass, and assuming the resulting pseudo heat of reaction of the second vessel is equal to the heat of reaction of the first vessel to create reliable isothermal reaction characteristics and identify optimal reaction parameters for the desired reaction heat profile over time.

In some embodiments of the present invention adiabatic control method for isothermal characteristics of reaction vessels for endothermic reactions, the control and adjustment means includes at least one programmable computer.

In some embodiments of the present invention adiabatic control method for isothermal characteristics of reaction vessels for endothermic reactions, the first vessel and the second vessel are of identical configuration and capacity.

In some embodiments of the present invention adiabatic control method for isothermal characteristics of reaction vessels for endothermic reactions, the initial volumetric amount of chemical reactants of the first vessel is equal to the initial volumetric amount of the at least one control material of the second vessel.

In some embodiments of the present invention adiabatic control method for isothermal characteristics of reaction vessels for endothermic reactions, the heating means for the first vessel is identical to the heating means for the second vessel.

In some embodiments of the present invention adiabatic control method for isothermal characteristics of reaction vessels for endothermic reactions, each of the first vessel and the second vessel further includes cooling means wherein cooling means for the first vessel is identical to the cooling means for the second vessel.

In some embodiments of the present invention adiabatic control method for isothermal characteristics of reaction vessels for endothermic reactions, the first vessel and the second vessel include temperature sensors connected to a computer, wherein the computer records and stores temperature readings at preprogrammed times for both the first vessel and the second vessel.

In some embodiments of the present invention adiabatic control method for isothermal characteristics of reaction vessels for endothermic reactions, the reaction in the first vessel is performed in a liquid medium and the at least one control material in the second vessel includes a liquid.

In some embodiments of the present invention adiabatic control method for isothermal characteristics of reaction vessels for endothermic reactions, the method steps a) through h) are repeated for a plurality of different stoichiometries of the chemical reactants of the first vessel.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is a diagrammatic presentation of various embodiments of the present invention adiabatic control method for both isothermal exothermic reactions and isothermal endothermic reactions;

FIG. 2 is a front oblique view of one set of reaction vessels that may be utilized in the present invention method;

FIG. 3 is a graph of the energy change involved in an isothermal exothermic reaction of a first vessel of the present invention method;

FIG. 4 is a graph of the temperature change involved in an adiabatic cooling of a non-reaction of a second vessel in which the cooling parallels the cooling of the first vessel of the present invention method shown graphically in FIG. 3;

FIG. 5 is a graph of the energy change involved in an isothermal endothermic reaction of the present invention method; and,

FIG. 6 is a graph of the temperature change involved in an adiabatic heating of a non-reaction of a second vessel in which the heating parallels the heating of the first vessel of the present invention method shown graphically in FIG. 5.

### DETAILED DESCRIPTION OF THE EMBODIMENTS

One of the main objectives of the present invention method is to provide a way of determining heats of reaction for different reactions, or for the same reaction with various parameters changed (set temperatures, ratios of reactants (referred to herein as “stoichiometries”)), and to utilize the information obtained to optimize desired reaction outcomes. In other words, the present invention method involves performing isothermal reactions in a first vessel, paralleling the isothermal temperature controls (adding or removing heat) to a second (non-reaction) vessel with at least one non-reacting control material, and calculating a pseudo heat of reaction for the adiabatic (pseudo) second vessel utilizing the heat change over time, the at least one control material heat capacity and mass. We then assume the resulting pseudo heat of reaction of the second vessel is equal to the actual heat of reaction of the first vessel. The term “pseudo heat of reaction” is a phrase used herein for the apparent heat of reaction that would have been realized, should a reaction have occurred in Reactor 2. Thus, the “pseudo heat of reaction” is the sum of the changes in temperature for specified increments of time, multiplied by the heat capacity of the non-reactant material(s) and multiplied by the mass of the non-reactant material(s).

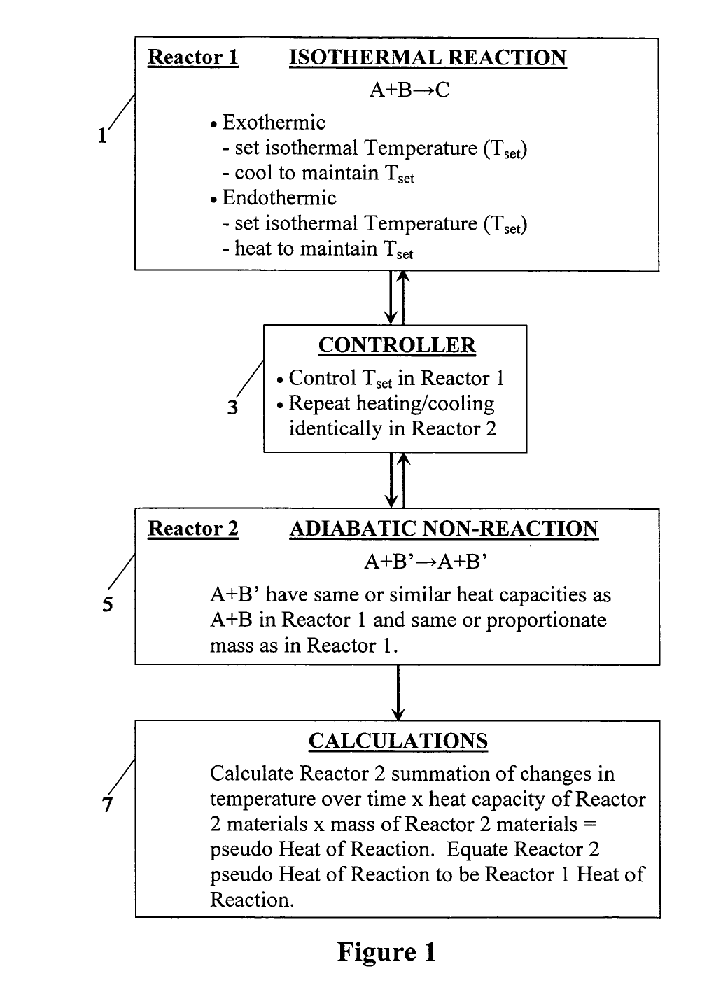

FIG. 1 is a diagrammatic presentation of various embodiments of the present invention adiabatic control method for both isothermal exothermic reactions and isothermal endothermic reactions. Frame 1 represents the first reactor (Reactor 1) and Frame 5 represents the second reactor (Reactor 2) with non-reactant materials. Frame 1 shows Reactor 1 having reactants A and B that react to produce product C. Frame 5 shows non-reactants A and B′ that do not react. The non-reactant material(s) should have the same or similar heat capacity as the reactants, and should have the same mass (or a proportionate mass). In fact, any number of reactants for a particular desired reaction could be used, and they could be liquids, solids, combinations, mixtures, solutions, sols, dispersions, etc. The non-reactant material of the second vessel Reactor 2 may be a single material or a plurality of materials, as long as they do not chemically react. The non-reactant materials may likewise be liquids, solids, combinations, mixtures, solutions, sols, dispersions, etc.

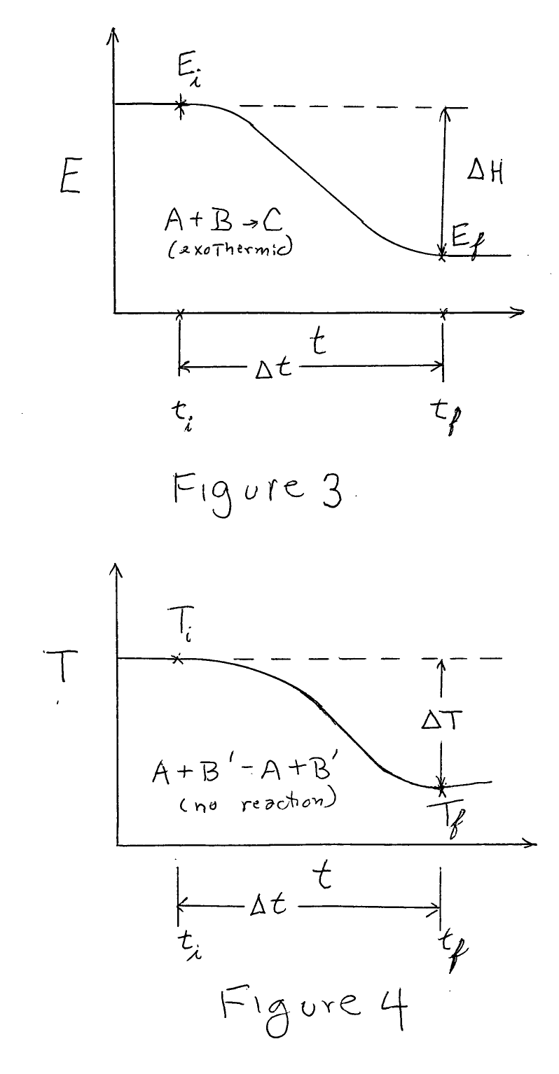

As shown in Frame 1, for exothermic isothermal reactions, a desired isothermal temperature T set is inputted to the system via the controller, Frame 3. Cooling is applied to the Reactor 1 to maintain T set, and the identical cooling (quantity and timing) is applied to Reactor 2 to chill down the non-reactants of Reactor 2. The energy change for this exothermic reaction in Reactor 1 is shown in FIG. 3 and the concomitant temperature change in Reactor 2 is shown in FIG. 4, both discussed in more detail below.

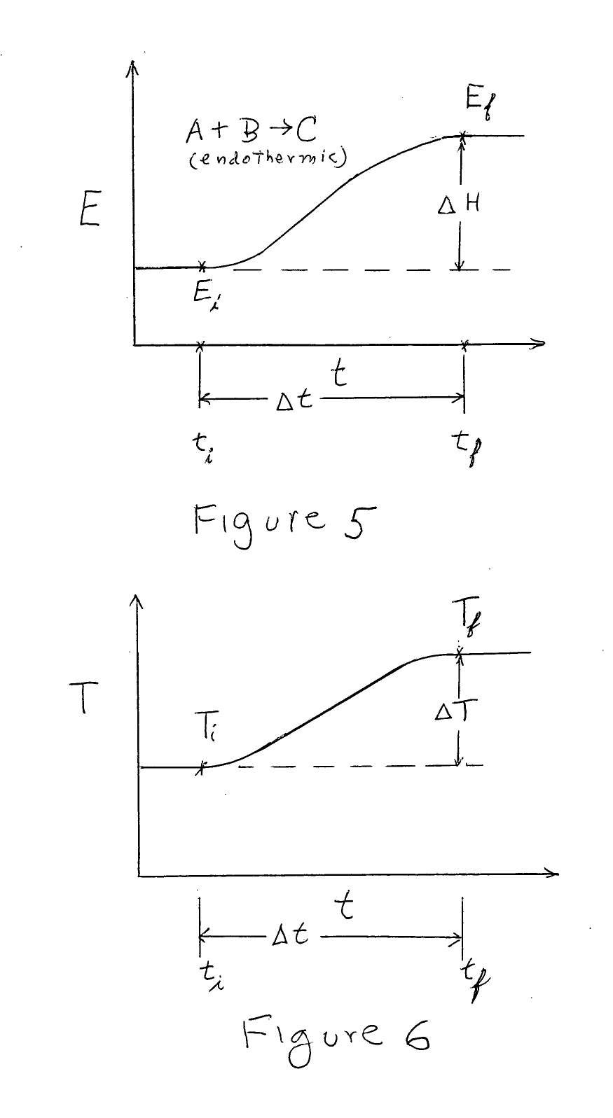

For endothermic isothermal reactions, a desired isothermal temperature T set is inputted to the system via the controller, Frame 3. As the endothermic reaction proceeds, heating is applied to the Reactor 1 to maintain T set, and the identical heating (quantity and timing) is applied to Reactor 2 to heat up the non-reactants of Reactor 2. The energy change for this endothermic reaction in Reactor 1 is shown in FIG. 5 and the concomitant temperature change in Reactor 2 is shown in FIG. 6, both discussed in more detail below.

Frame 7 of FIG. 1 illustrates the calculations made with the resulting data obtained and the basic characteristics of the non-reactant material(s). These calculations are as follows: Calculate Reactor 2 summation of: changes in temperature over time multiplied by heat capacity of Reactor 2 materials multiplied by mass of Reactor 2 materials. The result is equal to the pseudo heat of reaction for Reactor 2. The Reactor 2 pseudo heat of reaction is equated to be the Reactor 1 heat of reaction for the actual Reactor 1 reaction. This information may be generated for different set temperatures and different stoichiometries to determine the optimum parameters and characteristics to achieve desired results, such as least energy consuming, or maximum yield, or fastest production for a given yield, or other desired optimization results. The stored heats of reaction for given time periods may be minutely controlled and reliably repeated utilizing the methods of the present invention.

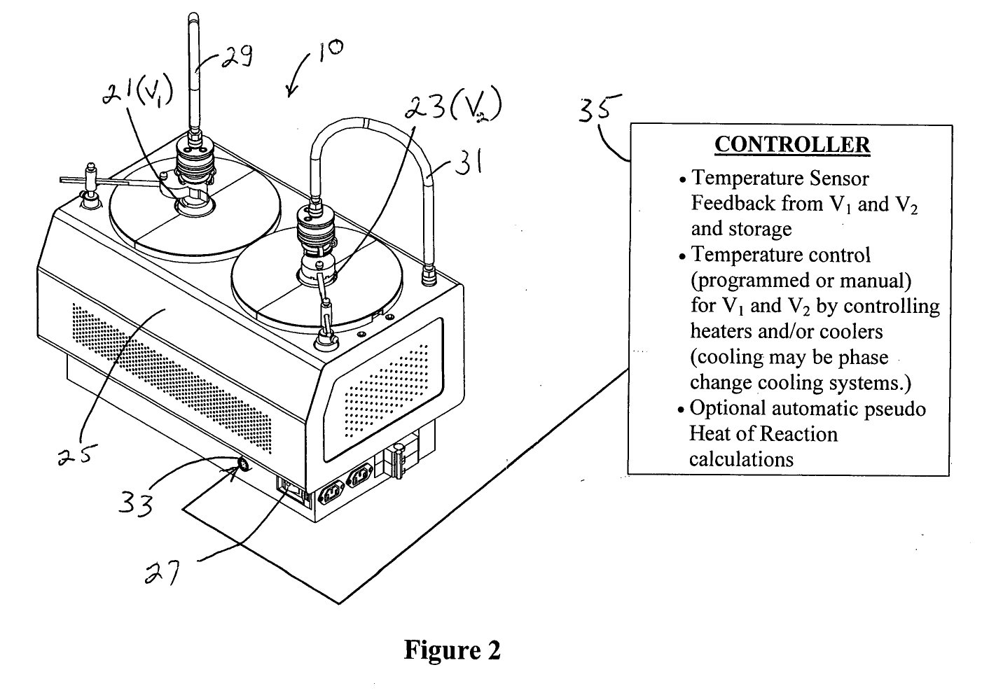

FIG. 2 is a front oblique view of one set of reaction vessels that may be utilized in the present invention method. Here, main instrument 10 has a main housing 25, a power control 27 and a computer controller port 33 for controller 35. The main housing 35 has been designed to house two reaction vessels 21 and 23, also shown as vessels V1 and V2, respectively. These are identical vessels, extremely well insulated and contain separate, dedicated, isolated heaters and coolers. The heaters and coolers may be any available devices and are located in their respective internal insulated chambers (not shown) adjacent the reaction vessels. The vessels also have controlled input lines 29 and 31 respectively, and may have inert blankets of gas, and other reaction features. Controller 35 includes temperature sensing, temperature versus time data storage, temperature control and may be programmed to do the pseudo heat of reaction calculations.

FIG. 3 is a graph of the energy change involved in an isothermal exothermic reaction of a first vessel of the present invention method and FIG. 4 is a graph of the temperature change involved in an adiabatic cooling of a non-reaction of a second vessel in which the cooling parallels the cooling of the first vessel of the present invention method shown graphically in FIG. 3. In an exothermic reaction, the energy is released (heat is given off). In this first vessel, in order to maintain a constant temperature vessel (isothermal reaction), cooling must be provided to keep the released heat from increasing the temperature of the reactants. At the starting time of the reaction tᵢ, the energy of the reactants is Eᵢ, as shown on the graph in FIG. 3. As the reaction proceeds to completion or to a finish point at time t_{f}, the energy of the resulting products (and possible unreacted reactant(s)) is E_{f}. The difference between the starting energy Eᵢ and the ending energy E_{f} is the heat of reaction (ΔH). The curve shows a slow beginning, a steady downward middle slope and a slow ending, with a reduction in energy. FIG. 4 represents the parallel processing of non-reactants in an identical or equivalent second vessel, showing temperature change over time, as the same amount and method of cooling to the first vessel is applied to this second vessel. The curves are similar, and the difference between Tᵢ, the starting temperature of this second vessel at tᵢ, and T_{f}, the ending temperature of this second vessel at t_{f}, is the ΔT used to calculate a pseudo heat of reaction:

Pseudo ΔH=sum of all (ΔT for each measurement at each time tᵢ to t_{f})×(heat capacity of the second vessel material(s))×(mass of the second vessel material(s)). The resulting value is presumed to be the heat of reaction of the actual reaction occurring in the first vessel. So if the pseudo-heat of reaction of the second vessel is 56 joules, then the heat of reaction of the first vessel is 56 joules. Also, the heat of reaction from the initial start time to any point in time prior to the end time, will be used to obtain the actual heat of reaction of the first vessel for that time frame.

FIG. 5 is a graph of the energy change involved in an isothermal endothermic reaction of the present invention method and FIG. 6 is a graph of the temperature change involved in an adiabatic heating of a non-reaction of a second vessel in which the heating parallels the heating of the first vessel of the present invention method shown graphically in FIG. 5. In an endothermic reaction, the energy is absorbed (cooling occurs as heat is absorbed). In this first vessel, in order to maintain a constant temperature vessel (isothermal reaction), heating must be provided to keep the absorbed heat from decreasing the temperature of the reactants. At the starting time of the reaction tᵢ, the energy of the reactants is Eᵢ, as shown on the graph in FIG. 5. As the reaction proceeds to completion or to a finish point at time t_{f}, the energy of the resulting products (and possible unreacted reactant(s)) is E_{f}. The difference between the starting energy Eᵢ and the ending energy E_{f} is the heat of reaction (ΔH). The curve shows a slow beginning, a steady upward middle slope and a slow ending, with an increase in energy. FIG. 6 represents the parallel processing of non-reactants in an identical or equivalent second vessel, showing temperature change over time, as the same amount and method of heating to the first vessel is applied to this second vessel. The curves are similar, and the difference between Tᵢ, the starting temperature of this second vessel at tᵢ, and T_{f}, the ending temperature of this second vessel at t_{f}, is the ΔT used to calculate a pseudo heat of reaction:

Pseudo ΔH=sum of all (ΔT for each measurement at each time tᵢ to t_{f})×(heat capacity of the second vessel material(s))×(mass of the second vessel material(s)). The resulting value is presumed to be the heat of reaction of the actual reaction occurring in the first vessel. Just as with the exothermic reaction, here, for the endothermic reaction as well, if the pseudo-heat of reaction of the second vessel is 56 joules, then the heat of reaction of the first vessel is 56 joules. Also, the heat of reaction from the initial start time to any point in time prior to the end time, will be used to obtain the actual heat of reaction of the first vessel for that time frame.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

What is claimed is:

1. An adiabatic control method for isothermal characteristics of reaction vessels for exothermic reactions, which compromises:
a) providing at least one first vessel, being at least one reaction vessel, said at least one first vessel having cooling means;
b) providing at least one second vessel, being at least one non-reaction control vessel, said at least one second vessel having cooling means;
c) providing control and adjustment means for said first vessel cooling means and for said second vessel cooling means;
d) providing chemical reactants to said first vessel for an isothermal exothermic reaction to create at least one reaction product;
e) initiating a reaction in said first vessel with said chemical reactants and providing appropriate cooling as necessary to maintain a desired temperature to regulate the rate of reaction;
f) providing at least one control material that is non-reactant, to said second vessel for adiabatic measurements wherein said at least one control material has a similar heat capacity to chemical reactants of said first vessel;
g) cooling said second vessel in the same manner and rate of heat removal as said first vessel so as to effect temperature reduction over time, and measuring and storing said temperature reduction over time to determine heat change over time for said second vessel; and,
h) calculating a pseudo heat of reaction of said at least one control material of said second vessel utilizing said heat change over time, said at least one control material heat capacity and mass, and assuming the resulting pseudo heat of reaction of said at least one control material of said second vessel is equal to the heat of reaction of the reaction of said first vessel to create reliable isothermal reaction characteristics and identify optimal reaction parameters for the desired reaction heat profile over time.

2. The adiabatic control method for isothermal characteristics of reaction vessels for exothermic reactions of claim 1 wherein said control and adjustment means includes at least one programmable computer.

3. The adiabatic control method for isothermal characteristics of reaction vessels for exothermic reactions of claim 1 wherein said first vessel and said second vessel are of identical configuration and capacity.

4. The adiabatic control method for isothermal characteristics of reaction vessels for exothermic reactions of claim 3 wherein the initial volumetric amount of chemical reactants of said first vessel is equal to the initial volumetric amount of said at least one control material of said second vessel.

5. The adiabatic control method for isothermal characteristics of reaction vessels for exothermic reactions of claim 1 wherein said cooling means for said first vessel is identical to said cooling means for said second vessel.

6. The adiabatic control method for isothermal characteristics of reaction vessels for exothermic reactions of claim 3 wherein said cooling means for said first vessel is identical to said cooling means for said second vessel.

7. The adiabatic control method for isothermal characteristics of reaction vessels for exothermic reactions of claim 5 wherein said cooling means is a phase change cooling means.

8. The adiabatic control method for isothermal characteristics of reaction vessels for exothermic reactions of claim 1 wherein the first vessel and said second vessel include temperature sensors connected to a computer, wherein said computer records and stores temperature readings at preprogrammed times for both said first vessel and said second vessel.

9. The adiabatic control method for isothermal characteristics of reaction vessels for exothermic reactions of claim 1 wherein said reaction in said first vessel is performed in a liquid medium and said at least one control material in said second vessel includes a liquid.

10. The adiabatic control method for isothermal characteristics of reaction vessels for exothermic reactions of claim 1 wherein said method steps a) through i) are repeated for a plurality of different stoichiometries of said chemical reactants of said first vessel.

11. An adiabatic control method for isothermal characteristics of reaction vessels for endothermic reactions, which compromises:
a) providing at least one first vessel, being at least one reaction vessel, said at least one first vessel having a heating means;
b) providing at least one second vessel, being at least one non-reaction control vessel, said at least one second vessel having heating means;
c) providing control and adjustment means for said first vessel heating means, said second vessel heating means;
d) providing chemical reactants to said first vessel for an isothermal endothermic reaction to create at least one reaction product;
e) initiating a reaction in said first vessel with said chemical reactants and providing appropriate heating as necessary to maintain a desired temperature to regulate the rate of reaction;
f) providing at least one control chemical that is non-reactant, to said second vessel for adiabatic measurements wherein said at least one control chemical has a similar heat capacity to chemical reactants of said first vessel;
g) heating said second vessel in the same manner and rate of heat input as said first vessel so as to effect temperature increase over time, and measuring and storing said temperature increase over time to determine heat change over time; and,
h) calculating a pseudo heat of reaction of said at least one control material of said second vessel utilizing said heat change over time, said at least one control material heat capacity and mass, and assuming the resulting pseudo heat of reaction of said at least one control material of said second vessel is equal to the heat of reaction of the reaction of said first vessel to create reliable isothermal reaction characteristics and identify optimal reaction parameters for the desired reaction heat profile over time.

12. The adiabatic control method for isothermal characteristics of reaction vessels for endothermic reactions of claim 11 wherein said control and adjustment means includes at least one programmable computer.

13. The adiabatic control method for isothermal characteristics of reaction vessels for endothermic reactions of claim 11 wherein said first vessel and said second vessel are of identical configuration and capacity.

14. The adiabatic control method for isothermal characteristics of reaction vessels for endothermic reactions of claim 13 wherein the initial volumetric amount of chemical reactants of said first vessel is equal to the initial volumetric amount of said at least one control material of said second vessel.

15. The adiabatic control method for isothermal characteristics of reaction vessels for endothermic reactions of claim 11 wherein said heating means for said first vessel is identical to said heating means for said second vessel.

16. The adiabatic control method for isothermal characteristics of reaction vessels for endothermic reactions of claim 13 wherein said heating means for said first vessel is identical to said heating means for said second vessel.

17. The adiabatic control method for isothermal characteristics of reaction vessels for endothermic reactions of claim 15 wherein each of said first vessel and said second vessel further includes cooling means wherein cooling means for said first vessel is identical to said cooling means for said second vessel.

18. The adiabatic control method for isothermal characteristics of reaction vessels for endothermic reactions of claim 11 wherein said first vessel and said second vessel include temperature sensors connected to a computer, wherein said computer records and stores temperature readings at preprogrammed times for both said first vessel and said second vessel.

19. The adiabatic control method for isothermal characteristics of reaction vessels for endothermic reactions of claim 11 wherein said reaction in said first vessel is performed in a liquid medium and said at least one control material in said second vessel includes a liquid.

20. The adiabatic control method for isothermal characteristics of reaction vessels for endothermic reactions of claim 11 wherein said method steps a) through i) are repeated for a plurality of different stoichiometries of said chemical reactants of said first vessel.
